(19) United States
(12) Patent Application Publication
(10) Pub. No.: US 2008/0263106 A1
(43) Pub. Date: Oct. 23, 2008

(54) Database queuing and distributed computing

(76) Inventors: Steven Asherman, New York, NY (US); Arun Kumar, New Town (IN); Michael Asherman, Cambridge, MA (US); Andrew Pugliese, Glen Ridge, NJ (US); Joseph S. Barbaro, Cold Springs, NY (US)

Correspondence Address: DAY PITNEY LLP, 7 TIMES SQUARE, NEW YORK, NY, 10036-7311, US

(21) Appl. No.: 12/082,758

(22) Filed: Apr. 14, 2008

Related U.S. Application Data
(60) Provisional application No. 60/923,033, filed on Apr. 12, 2007.

(51) Int. Cl. G06F 17/30

(52) U.S. Cl. 707/202; 707/E17.117; 707/E17.002

(57) ABSTRACT

This disclosure relates to a high performance database queuing method and apparatus which supports reliable service-oriented architecture. The servers and clients add tasks to the queues, which are database table with records that point to other records in other tables. The application servers pick up tasks in priority (first-in-first-out) order to perform tasks, flag tasks as done, and delete records periodically. The queuing makes use of database strengths such as indexing, synchronization, transaction process, reliability and recovery.

This application claims priority under 35 U.S.C. §119(e) of provisional application Ser. No. 60/923,033 filed Apr. 12, 2007, the contents of which are hereby incorporated by reference.

### BACKGROUND OF THE INVENTION

1. Field of the Invention

The present invention pertains to database queuing and distributed computing method and apparatus. More particularly, the present invention pertains to high-volume, database transaction processing applications.

2. Description of the Prior Art

Distributed processing systems frequently use queues to coordinate work that is collectively performed by a pool of available machines. Entries are added to a queue (“pushed”) to request units of work, and entries are removed from the queue (“popped”) as the work is completed.

Queue manipulations must be fast enough to maintain adequate responsiveness and throughput, or the queue becomes a bottleneck. At the same time, the system must adhere to high standards of robustness and security required by mission-critical transaction processing applications.

A typical distributed processing scenario includes many interactive users remotely issuing transactions against a shared database. End users communicate across the Internet with a pool of web servers, which add tasks to the queue, so that work can be offloaded for asynchronous processing by other machines.

Typically, application servers pick up prioritized tasks from the queue, perform the appropriate actions, and flag queue entries as completed, deleting records periodically so the queue does not grow indefinitely.

Commonly assigned and commonly invented U.S. Pat. No. 7,181,474 deals with similar database issues, and is hereby incorporated by reference.

### OBJECTS AND SUMMARY OF THE INVENTION

It is therefore an object of the present invention to provide efficient queuing capability suited to the most demanding, high-volume database transaction processing applications.

It is therefore a further object of the present invention to provide a simple programming interface, automatic reliability and recovery features and comprehensive error handling and diagnostic facilities.

It is therefore a still further object of the present invention to provide an optimized design which integrates indexing, synchronization and transaction processing.

These and other objects are attained by providing a high performance database queuing method and apparatus which supports reliable service-oriented architecture. The servers and clients add tasks to the queues, which are database table with records that point to other records in other tables. The application serves pick up tasks in priority (first-in-first-out) order to perform tasks, flag tasks as done, and delete records periodically. The queuing makes use of database strengths such as indexing, synchronization, transaction process, reliability and recovery.

### BRIEF DESCRIPTION OF THE DRAWINGS

Further objects and advantages of the invention will become apparent from the following description and from the accompanying drawings and claims, wherein:

FIG. 1 is a diagram of the hardware for database queuing, applicable to an embodiment of the present invention.

FIG. 2 is an example of a single database queue pointing to multiple payload tables with different record layouts, applicable to an embodiment of the present invention.

FIG. 3 is an example of a queue structure, further illustrating the instruction layout, applicable to an embodiment of present invention.

FIG. 4 is an example of an active database queue with delayed deletions, applicable to an embodiment of the present invention.

FIG. 5 is a state diagram of state transitions of the database queue item status, applicable to an embodiment of the present invention.

FIG. 6 is a flow diagram of high speed queuing operation, applicable to an embodiment of the present invention.

### DETAILED DESCRIPTION OF THE PREFERRED EMBODIMENTS

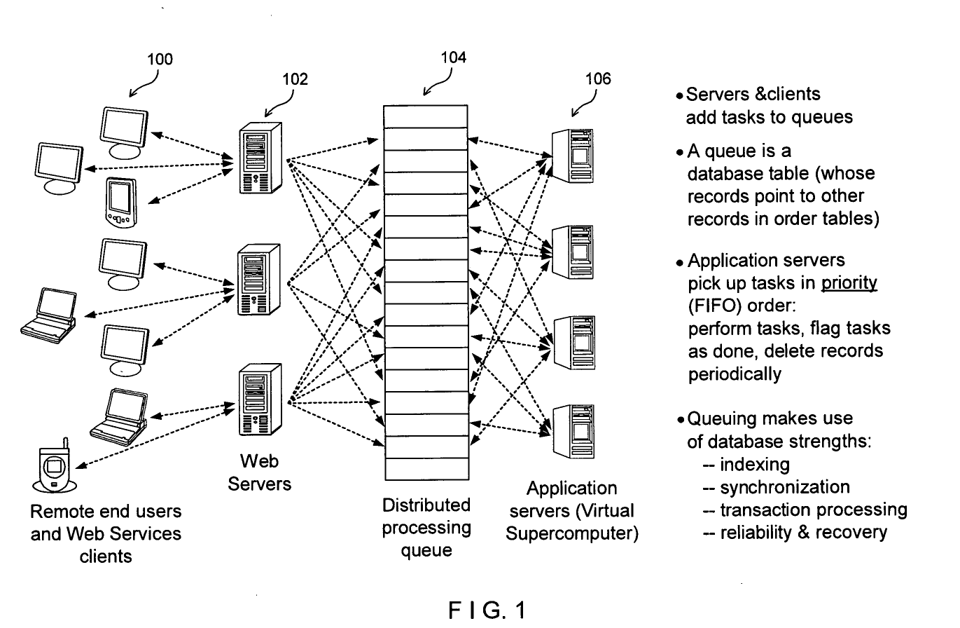

Referring now to the drawings in detail wherein like numerals refer to like elements throughout the several views, one sees that FIG. 1 is a diagram of the distributed processing environment, to which an embodiment of the present invention is applicable. Remote end users and web (internet) services clients enter tasks via personal computers, terminals, cell phones and other personal digital devices, collectively referred to by the numeral 100. These tasks are received by any number of web servers 102 which enter the tasks into a distributed processing queue 104 which is a database table with records that point to other records in other tables. The application servers 106, working in parallel (in some applications to an extent which may be envisioned as a virtual supercomputer), take up the queued tasks, typically in priority or first-in-first-out order (FIFO), although those skilled in the art will recognize that some embodiments may have any number of priority schemes for the various tasks. The application servers 106 perform tasks, flag tasks as completed and periodically delete records. The queuing of tasks makes use of database strengths such as indexing, synchronization, transaction processing, reliability and recovery.

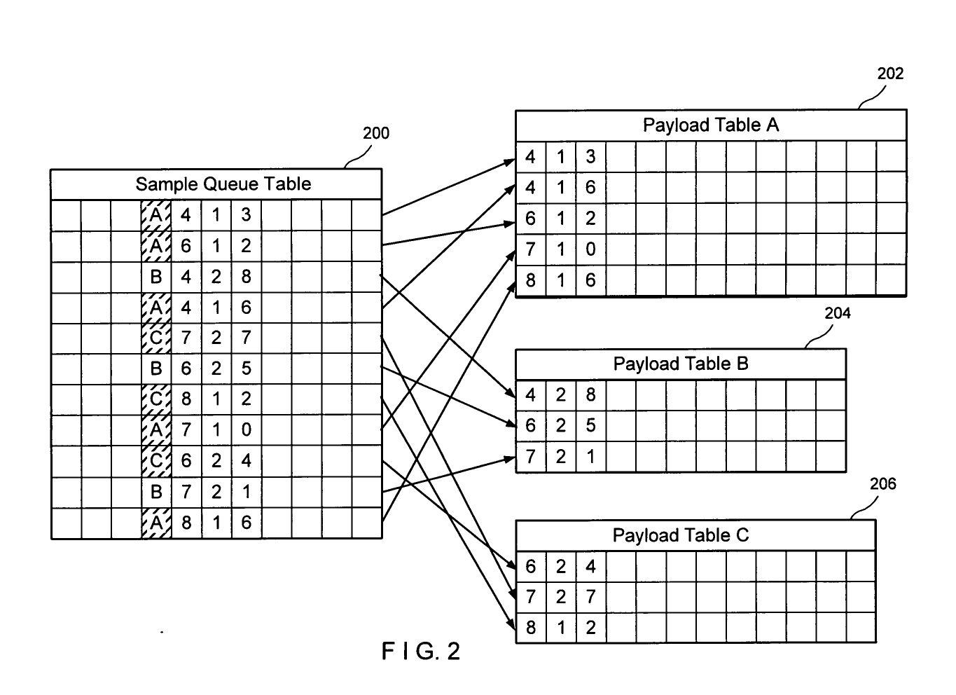

FIG. 2 illustrates a single database queue 200 with data pointing to multiple payload tables 202, 204, 206 with different record layouts (i.e., record formats, which may include differences in length) by using a flag A, B or C which points to payload tables 202, 204, 206, respectively.

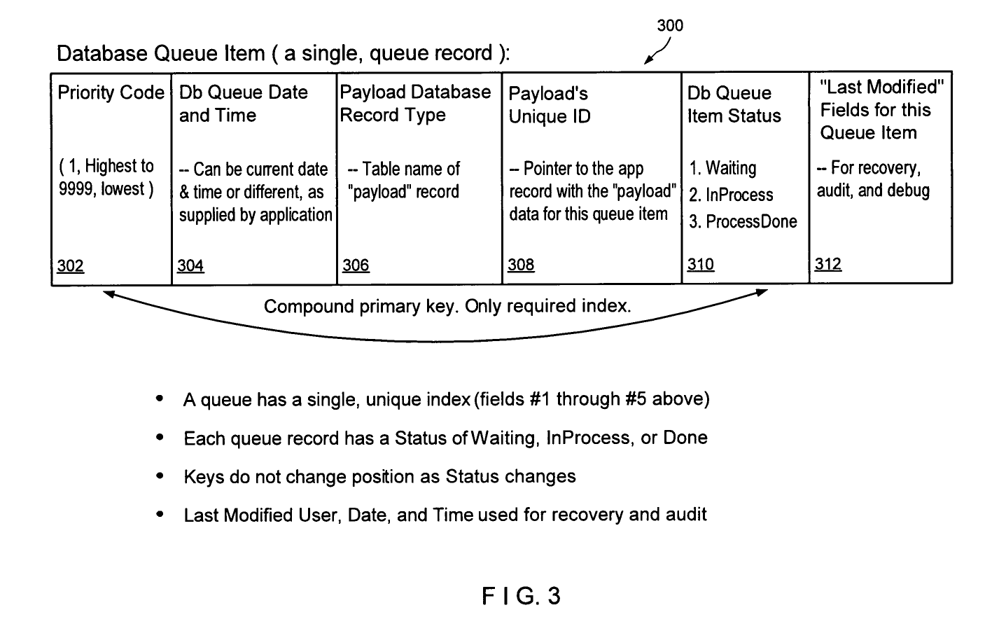

FIG. 3 illustrates a typical instruction lay-out 300 within the distributed processing queue 103. A typical instruction lay-out includes priority 302, date/time scheduled 304, payload type 306, payload identification 308, status 310 (typically waiting, in process or done) and information (typically user date and time, used for recovery and audit) regarding last modification 312. Typically, queues include single, unique indices and keys do not change position as status changes.

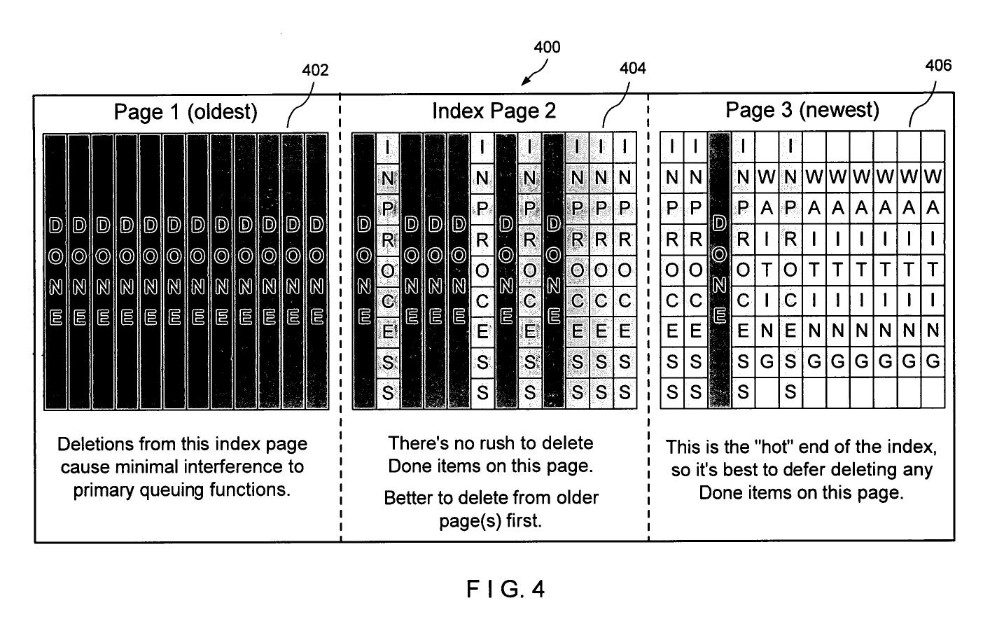

FIG. 4 illustrates an active queue 400 with delayed deletions of entries. While FIG. 4 is illustrated with three pages, first page 402 (the oldest), second page 404 (intermediate in age) and third page 406 (the newest), it is envisioned that typically more than three pages employ this configuration. Deletions from the oldest index page 402 cause minimal interference to the primary queuing functions. Deletions from the intermediate page 404 are not urgent and it is typically preferred to make deletions from the oldest index page 402. Similarly, it is preferable to defer making deletions from the newest page 406.

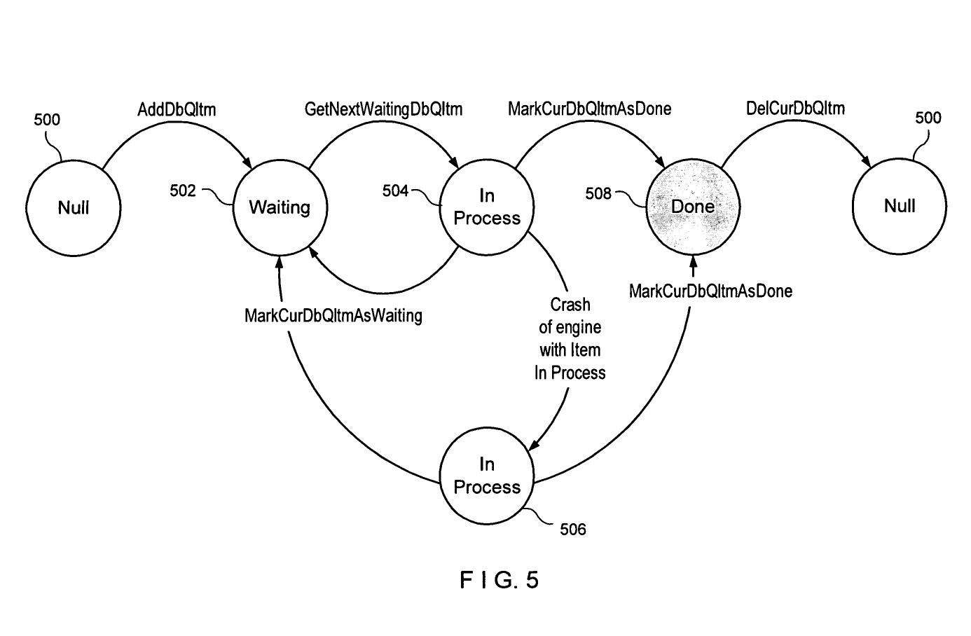

FIG. 5 illustrates the state transition of the database queue item status. Null state 500 (illustrated for simplicity twice on FIG. 5) which can transition to the waiting state 502. The waiting state 502 can transition to the in-process state 504. The in-process state can have any of three outcomes—transition back to waiting state 502, transition to crashed (e.g. failure) in process state 506 or the done state 508. The done state 508 can thereafter transition to the null state 500.

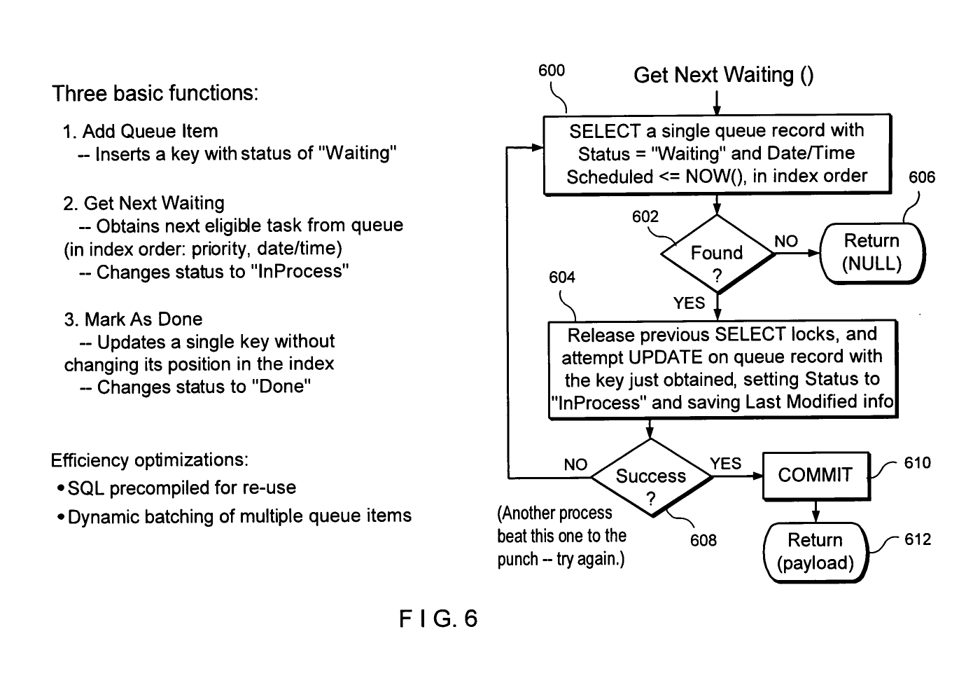

FIG. 6 illustrates a flow diagram of high speed queuing operation, applicable to an embodiment of the present invention. In block 600, a single queue record or task is selected. If this queue record is found, as determined by decision block 602, then in block 604, the previous select locks are released and an update on the queue record with the key obtained is attempted, changing the status to “in process” (see state 504 in FIG. 5) and saving the information regarding last modification (see column 312 in FIG. 3). If this queue record is not found, as determined by decision block 602, then the request is returned as null in block 606.

If the functions of block 604 are completed successfully, as determined by decision block 608, then the changes instructed by the original commanded are performed or committed in commit block 610 and the process returns via return block 612. If the functions of block 604 are not completed successfully, as determined by decision block 608 (which can include a preceding conflicting task), the process returns to block 600. In short, this illustrates the sequence of adding a queue item (with a “waiting” status, see block 502 in FIG. 5), get the next waiting task based on priority (changing to an “in process” status, see block 504 in FIG. 5), updating a single key without changing its position in the index and changing the status to “done” (see block 508 in FIG. 5). Efficiency can be improved by pre-compiling the SQL for re-use and by dynamic batching of multiple queue items.

The resulting embodiment provides for queuing in a database thereby allowing for recovery in a high activity environment. The queue includes a single unique index arranged in a way in which the index entry does not have to move as the processing is done, thereby decreasing the need to lock the index entries This is an important optimization for increasing the speed of adding queue records and markedly decreasing the chance of deadlock due to index page contention. Furthermore, this allows for deletion of the record to be delayed until the record reaches less active portions of the queue (moved after processing of the record is completed), so that substantial database processing can occur without overly interfering or causing deadlock. Furthermore, a system is thereby implemented whereby very long transactions, which are broken into a number of smaller transactions, can be interrupted or recovered, in that an indicator that the queue item remains in process until the entire process is done. The process can be easily be rolled forward or back, as necessary.

Each of the components of a distributed processing system can be scaled to increase its capacity and improve performance as required. High-speed communications hardware makes it possible to “scale out” simply by adding more web servers, but the need for this expense can be reduced by utilizing distributed processing to keep web servers focused on their primary function. Likewise, we can increase the number of application servers to handle a virtually unlimited workload, and these machines need only be able to communicate with the database.

The queue itself can be scaled simply by introducing multiple queues, if the degree of contention for a single queue makes this necessary. The present embodiment is designed to minimize the duration and scope of locking that takes place during queuing operations, so a high degree of performance is possible even with a single queue.

Finally, the database can be scaled up, as well as out, to an extremely high capacity. For example, the database can be scaled by incorporating:
more memory (RAM)
more powerful multiprocessor, e.g. 64-bit Symmetric Multiprocessor (SMP)
multiple database servers
dividing up tables and indexes across multiple boxes
partitioning tables across multiple boxes
coordinated caching, e.g. Oracle Real Application Clusters (RAC)
high speed communication channels
Redundant Arrays of Inexpensive Disks (RAID)
Network Attached Storage (NAS)
Storage Area Networks (SAN)
Solid State Disk (SSD), Caching controller, hybrid disk, e.g. for redo log

Further to FIG. 3, a queue is a database table whose records contain the following fields:

1. PRIORITY (PriorityCod) (see FIG. 3, element 302)

A number from 1 to 9999, where 1 is regarded as the highest priority. Tasks are processed in priority order. (Priority is determined by the application that adds the queue record, for example, by using priority of Customer, User, and/or service-level agreements.)

2. DATE/TIME SCHEDULED (DbQDate, DbQTim) (see FIG. 3, element 303)

The earliest date and time when this task may be executed. Within a given priority, this determines the sequence of processing.

The Database Queue Date and Time fields are used automatically when retrieving queue records. They can be the current date and time or different, as supplied by the application adding the queue record. (For most applications, the current Database Server Date and Time, as retrieved efficiently by the Database Manager, is the best choice for the Database Queue Date and Time.)

Database Queue Time is in milliseconds ( 1/1000 of a second). So, the date/time is not guaranteed to be unique, but close to unique most of the time (depending on how fast queue records are added).

An item is not picked up until the Database Queue Date/Time is <=(less than or equal to) now. So, for example, to schedule an operation for 10 minutes from now (or later), the Database Queue Date/Time should be set to the Database Server Date/Time plus 10 minutes.

3. PAYLOAD TYPE (PayloadRecTypNam) (see FIG. 3, element 306)

Names the record type (i.e., a table name) containing an associated “payload” for this task. The full info about this table is maintained in the data dictionary. Notice that a single queue can point to multiple payload formats, corresponding to multiple database record types.

4. PAYLOAD ID (PayloadLastModUsrCod, PayloadLastModDate, PayloadLastModTim) (see FIG. 3, element 308)

Identifies a unique corresponding record in the payload table. The payload provides any additional static parameters needed to process this unit of work.

The Payload ID acts a pointer to the application record that contains the actual “payload” data for this queue item. It is the Last Modification Key of the payload record (User Code, Date, Time) and is unique across the database.

The “Payload” fields (PayloadRecTypNam, PayloadUsrCod, PayloadDate and PayloadTim) taken together form a guaranteed unique identifier within the database, and they point to the record (table and row) that an application associates with the particular queue item.

5. STATUS (DbQItmStatCod) (see FIG. 3, element 310)

A code indicating whether the task is:

Waiting: to be picked up for execution

InProcess: currently executing (or crashed)

Done: completed and ready for deletion

6. LAST MODIFIED INFO (LastModUsrCod, LastModUsrDate, LastModUsrTim) (see FIG. 3, element 312)

A unique identifier specifying when this record was last changed, and by whom. (Used only for recovery, audit, and debugging.)

The Last Modified fields are not in the primary key (but are unique across the database).

The queue has a single index, which defines a primary key formed from the concatenation of fields 1-5 (FIG. 3, elements 302, 303, 306, 308, 310), i.e. all except the Last Modified information. Keys are guaranteed to be unique, because each queue record is associated with a unique payload.

This index allows fast lookup of a given queue record, as well as providing an efficient basis for PRIORITIZED, first-in, first-out (FIFO) processing. By avoiding the need to maintain multiple indexes, queue manipulations are kept as fast as possible, and the chance of deadlock is reduced.

Another aspect of the index optimization of the present embodiment is the characteristic that the location of keys within the index tends to be relatively stable as entries are added, updated, and deleted. This minimizes the extent of dynamic index reorganization, further reducing contention during updates to index pages under intensive concurrent usage.

The present embodiment supports the following three primary functions:

### ADD QUEUE ITEM (AddDbQItm)

Adds an item to the queue, effectively scheduling a piece of work to be performed by another machine. This entails inserting a single new key into the queue's index, with a status of “Waiting”.

### GET NEXT WAITING (GetNextWaitingDbQItm)

Obtains the next eligible task from the queue, in index sequence, changing this item's status from “Waiting” to “InProcess”.

This is the function for grabbing the next eligible task from the queue. The algorithm used performs an efficient index traversal, without needing to lock more than one index page at a time. This helps to assure that a high degree of concurrency can be maintained under a heavy load of simultaneous traffic.

### MARK AS DONE (MarkCurDbQItmAsDone)

Indicates the completion of task in the queue, causing its status to go from “InProcess” to “Done”. This is accomplished by a simple update, affecting a single, known key in the index, and leaving its position unchanged.

As an optimization, the present embodiment automatically reuses precompiled SQL for repeatedly used commands. Additional functions allow dynamic batching of multiple queue items, to further reduce the overhead of handling a high volume of small transactions.

Moreover, in order to keep the queue and its accompanying payload table(s) from growing endlessly, there must be a mechanism for “garbage collection”, i.e. the physical deletion of records that are no longer needed. The present embodiment increases the efficiency of garbage collection by minimizing its impact on the speed of the primary queuing functions.

The garbage collection can operate automatically, as well as support various flexible cleanup options. The approach of the present embodiment is its separation of the action that marks the completion of a task from the actual deletion of the corresponding queue record and its associated resources. Instead of doing an immediate deletion upon the MarkAsDone operation, a very fast update is made to the Status field, and the deletion is deferred. This delayed method of dynamic garbage collection provides a substantial boost in efficiency.

To synchronize concurrent queue manipulations, index pages are locked and unlocked automatically by the underlying database system (DBMS). The queuing functions have been designed to enable fast DBMS execution with the briefest possible duration of locking, so that a high rate of concurrent activity can be supported.

However fast the individual queuing operations, another factor that can dramatically affect queue performance is the pattern of locality among the many operations that take place under intensive usage. If too many actions require locking a common index page, those operations may be slowed down considerably, waiting in turn, instead of running in parallel. Conversely, if the actions are more spread out across multiple index pages, the effect of locking diminishes, because conflicts are less frequent. This is the point of delayed garbage collection: it reduces contention for the most active index pages, thereby enhancing concurrency. It is typically more efficient to delay garbage collection until the affected pages are not too close to the “hot” end of the queue.

One of the primary motivations for implementing the queue as a database file is to get the benefit of database transaction processing (TP) reliability and recovery features. The queue generally contains valuable information about work to be done, some of which has not yet been recorded elsewhere. The underlying database TP facilities provide assurance, to an arbitrarily high degree of certainty, that the queue itself can be recovered after any crash, up to the most recently committed transaction.

Beyond guaranteeing recoverability of the queue, the present embodiment further assures that both the queue and the rest of the database can be collectively recovered to a mutually consistent state, one of the fundamental tenets of TP. To accomplish this, the present embodiment simply incorporates the queue directly into the database, rather that treating it as an external entity that must somehow be integrated to work in concert with the DBMS-provided TP mechanism. Besides greatly simplifying a thorny problem, the present embodiment is thus able to employ the most efficient, low-level methods for coordinating fine-grained, asynchronous processing.

DBMS-level TP only handles a portion of the complete recovery problem, that of restoring the queue and the database to its most recent state. One must also consider how to deal with the system's interrupted condition, so that normal operation can be resumed as soon as possible. Also we must contend with the common situation of partial failures, where one or more application servers crash, but the database and rest of the distributed system keeps running.

The present embodiment supports a recovery procedure that enables rapid resumption of normal system operation after such interruptions and partial failures. Only those queue items whose Status is “InProcess” need to be considered, and the recovery of these tasks generally reduces to simply resetting their Status to “Waiting”. For partial failures, the present embodiment can use the identifier of a crashed server and time of its demise to narrow down the selection, since the id and timestamp are stored as a part of the “Last Modified” field of each queue record. In short, the recovery procedure of the present embodiment is fast, because it can be done in a single efficient pass.

Therefore, the present embodiment demonstrates how it is possible to do high performance, large scale distributed processing, without resorting to complex and costly solutions. Properly used, the native capabilities of modem database management systems can be employed to construct efficient distributed systems that scale to massive proportions.

The design of the present embodiment fully exploits the greatest strengths of database technology, indexing and transaction processing, to provide a unique capability that offers speed, reliability, and scalability. Through its simplicity, the present embodiment achieves efficiency, but no less important is the resultant ease it provides to programmers and designers faced with the challenge of building large distributed applications.

The methods used for transaction processing in the present embodiment make the rules for programming straightforward. A queue record is added (INSERT and COMMIT) using the AddNextDbQItm function. The application can choose to make this a single record transaction, or end a series of record operations with this command, resulting in a multi-record transaction. The concurrency and performance of the queue will be improved if the application calls AddNextDbQItm as a SINGLE record transaction, i.e. after doing a COMMIT on any prior database operations. (For many applications, good results can be obtained without reliance on multi-record transactions.)

Getting the next available queue record causes a transaction (UPDATE and COMMIT). The change of the status from “Waiting” to “InProcess” is always done as a single record transaction (automatically by GetNextDbQItm).

Queue operations can participate in multi-record transactions. It is up to the application whether to make the switch from “InProcess” to “ProcessDone” part of a multi-record transaction (to guarantee that once the operations are done, the status will never be left as “InProcess” even if there is a crash right at the end of the processing). For many applications, this is not necessary. Often, it is sufficient to guarantee that the change to “ProcessDone” status is always the last action done when all other processing has been completed (by calling MarkDbQItmAsDone).

>>The instructions and components for the present embodiment include the following:

Record Database Queue Class (clsRecDbQ)

The Record Database Queue class (clsRecDbQ) provides an interface for high speed queuing. The class represents an area of main memory for holding a single queue item (record), for adding (“pushing”) a new item onto the queue, for retrieving (“popping”) the next item on the queue, and deleting queue records when they have been processed. The term “record” as used here is synonymous with a relational “column”, and each queue corresponds to a single table of a relational database.

Besides standard record handling operations, such as setting and getting data in particular fields (columns), the Database Queue Record class interface includes these functions:

InitDbQItm, AddDbQItm, GetNextWaitingDbQItm, GetData, SetPrepareCmdFlag MarkCurDbQItmAsDone, MarkCurDbQItmAsWaiting, FindInProcessDbQItm GetNextDoneDbQItm, DelCurDbQItm GetNextCrashedDbQItm (for recovery)

In the present embodiment, clsRecDbQ can be constructed at any time, but the InitDbQItm function must be called before other operations are performed on the record buffer. To reduce programming errors, many typical record operations are typically not directly supported, including AddRec (INSERT), ChgRec (UPDATE), DelRec (DELETE) and GetRec (SELECT).

Using a Database Queue to coordinate work involves repeating these four steps:

1) “PUSH”: An application adds a record to the queue to schedule work to be picked up by a Batch application. (AddDbQItm)

2) “POP”: Another application finds the next item to process. (GetNextWaitingDbQItm)

3) Do work: Processing is done on the queue item (or cancelled) by the application that picks up the work. (MarkCurDbQItmAsDone, MarkCurDbQItmAsWaiting)

4) Clean up: Applications that queue items are responsible for regularly deleting records that are no longer needed. (DelCurDbQItm)

Calling SetPrepareDbCmdFlag with TRUE before manipulating the queue, allows for significantly improved performance when the queue is being accessed repeatedly. (Internally, two database buffers are used to represent the single Database Queue buffer interface. The application programmer does not have to manage multiple database buffers to get the advantages of having multiple commands Prepared by the database for repeated invocation.)

It is important to note that there should be no more than one Queue item for a given Payload record. A given Payload record should only be pointed to in one Database Queue at a time. It is typically considered to be a programming or design error to have more than one queue item pointing to the same Payload record.

The typical Required Database Queue Record Layout follows:

Any record type (table) that has the following fixed format can be manipulated as a Database Queue (as well as the standard Record and Record Set interfaces). This is the required database field (column) structure for all Database Queues -

1. Priority Code (PriorityCod)

2. Database Queue Date (DbQDate)

3. Database Queue Time (DbQTim)

4. Payload Record Type Name (PayloadRecTypNam)

5. Payload Last Modified User Code (PayloadLastModUsrCod)

6. Payload Last Modified Date (PayloadLastModDate)

7. Payload Last Modified Time (PayloadLastModTim)

8. Database Queue Item Status Code (DbQItmStatCod)

9. Last Modified User Code (LastModUsrCod)

10. Last Modified Date (LastModDate)

11. Last Modified Time (LastModTim)

In addition, typically for the Record Database Queue class to work, there must be unique, compound index including fields #1 through #8, that is every field except the LastMod User Code, Date, and Time. The records LastMod info is only used for recovery and audit purposes. To prevent slower performance and deadlock with multiple users, there should not be a LastModKey index (or other index) on a Database Queue record type.

In the present embodiment, for reading batches of queue items and processing them together, instead of “popping” a single item at a time, an application can read multiple items before processing them. This supports efficient “batching” of similar work. For example, an engine might continuously read in new payload records (with GetNextWaitingDbQItm) until a record is retrieved that should not be part of that batch.

Then, the application processes all the retrieved queue items (but the last) and then marks them as Done. FindInProcessDbQItm( ) is used to reposition in the queue and change the current Db Queue Item, so that MarkCurDbQItmAsDone( ) can be called for all queue records in the batch.

In the present embodiment, for database queue error handling, as opposed to standard database modification, many of the Database Queue functions are intended to always succeed, if programmed correctly. For example, AddDbQItm, MarkCurDbQItmAsDone, MarkCurDbQItmAsWaiting, and FindInProcessDbQItm do NOT have return codes because, if used as intended, only successful operations occur. By throwing errors otherwise, the developer is warned that there is a problem, most likely in multiple application instances stepping on each other's queue items. Only one application instance at a time should be changing a queue item or its payload, and errors thrown by these void functions indicate a programming (or operations) problem.

The main member functions of clsRecDbQ are described in more detail as follows:

Member function: clsRecDbQ::InitDbQItm
Full name: Initialize Database Queue Item Function of clsRecDbQ

The purpose is that the InitDbQItm function specifies the specific Database Queue (table) to be operated on, which must be in the Data Dictionary and have the standard Database Queue format.

The InitDbQItm function prepares a Record Database Queue buffer for use and associates it with the specified queue record type (table) of the current database. Information from the data dictionary is used for allocating the Record Database Queue buffer in main memory.

Member function: clsRecDbQ::AddDbQItm
Full name: Add Database Queue Item Function of clsRecDbQ

The purpose of AddDbQItm is to add a queue “item” to the database queue effecting a “PUSH” operation on the database queue. Interactive or Batch applications use AddDbQItm to add records to a queue to schedule work to be picked up by some other application.

A call to AddDbQItm does an INSERT (AddRec) of a single Database Queue record into the queue. AddDbQItm always sets the Queue Item Status to “Waiting” (i.e. ready to be picked up by some Batch process) and also sets the queue record's Last Modified info (User Code, Date, and Time).

Before adding a queue item, the application must add a “payload” record to the database. Other associated records can be added, one at a time, and no action should be initiated against them until an associated queue record is added. This last step signals the start of a unit of work (because picking up the queue item is used to initiate that work).

Once the queue record has been initialized, an application calls:

AddDbQItm with a “pointer” (unique ID) to the payload record. (Calling AddDbQItm can only be done after the queue has been initialized and the associated data has been added to the database).

In is important to note that in the present embodiment, in order to avoid database queue addition errors, it is up to the application program to insure that one and only one queue record points to any given payload record.

A fatal exception is thrown if, for any reason, a call to AddDbQItm attempts to add a duplicate queue key—which must be the result of a programming error.

Member function: clsRecDbQ::GetNextWaitingDbQItm
Full name: Get Next Waiting Database Queue Item Function of clsRecDbQ

The purpose of GetNextWaitingDbQItm( ) is to retrieve the next available queue item from the database queue to be processed by the application, thus effecting a “POP” operation on the database queue.

Determining which Waiting item is next is done on a modified FIFO (first-in, first-out) basis. Higher priority queue items are always returned before lower priority queue items, even if the lower priority item has an earlier date. In addition, a Waiting queue item is not returned until the date/time is less than or equal to NOW. (The calculated Database Server Date and Time is used internally to determine whether the Database Queue Date and Time for an item is <=now.)

The application “pops” (reads) one queue record at a time and processes the payload record pointed to by that queue record. Note that, traditionally, “pop” implies a deletion, whereas in the Database Queue implementation, delete is not done at this point. Instead, the queue record's status is changed from “Waiting” to “InProcess”, and a database COMMIT is done before retrieving the payload record (for which no locking is needed). It is definitely possible for two processes (or threads) to pick up the same queue record, but only one “wins”, and the other loses at changing the status to “InProcess”.

GetNextWaitingDbQItm either returns the queue item successfully, along with the associated payload record or returns a “NoDataFound” completion code. Whenever a queue item is returned, a payload record is also returned automatically. It is placed in the record buffer supplied as a parameter to the GetNextWaitingDbQItm function. If NoDataFound has been returned by the GetNextWaitingDbQItm call, then the payload record buffer is made empty (freed), and actions on it (other than initialization) are not valid.

Usage: The application calls GetNextWaitingDbQItm, which gets the highest priority, earliest item available. Before calling GetNextWaitingDbQItm, the application creates an empty record buffer (NO initialization is necessary). The application passes this object to GetNextWaitingDbQItm as a “receptacle” for receiving the payload record.

In the present embodiment, GetNextWaitingDbQItm does its work as follows. GetNextWaitingDbQItm starts by doing a SELECT for a SINGLE record in “Waiting” status with a Database Queue Date/Time <=now, and releases all locks. Queue items with a Queue Date and Time that has not occurred yet and are not picked up.

Then, GetNextWaitingDbQItm attempts to do an UPDATE (ChgRec) to set the Queue Item Status to “InProcess” using the queue record's unique key (specified in the WHERE clause). The queue record's Last Modified info (User Code, Date/Time) are also updated as part of this operation. If the record is updated successfully, COMMIT is done immediately, and another SELECT (GetRec) is done to retrieve the “Payload” record specified in the retrieved queue item.

If the queue record is not updated successfully (which changes the status), it means that some other process has gotten to it first. (Once the unique key, with Queue Item Status, is changed, the record will not be found because it does not satisfy the WHERE clause, which specifies a “Waiting”status). Then, GetNextWaitingDbQItm repeats the sequence by repeatedly looking for the next queue item until the function can successfully change a record's Queue Item Status to “InProcess” (or there are no more queue records left to search). (Internally, each time GetNextWaitingDbQItm fails to do the update because some other user has already changed the status, the function does another SELECT and tries again to change the Queue Item Status of the FIRST record in that logical result set.)

Internally, two separate database buffers are used for GetNextWaitingDbQItm, one for doing the SELECT to find the next candidate queue record, and the other for doing the UPDATE, to change the queue status. This allows for high efficiency, preparation (compilation) to be done for both of these database operations.

Member function: clsRecDbQ::MarkCurDbQItmAsDone
Full name: Mark Current Db Queue Item As Done Function of clsRecDbQ

The purpose is to indicate that processing has been done on the current queue item by the application. The Database Queue Item Status is changed to “ProcessDone”. The item must start out in “InProcess” status and must be found or an error is thrown. Alternatively, when a task is cancelled, the program can put the item back on the queue by calling MarkCurDbQItmAsWaiting, which sets the Database Queue Item Status back to “Waiting”.

When the task is completed, the application calls MarkCurDbQItmAsDone, which sets the current Database Queue Item Status to “ProcessDone”. This means “ready to delete” this queue item.

It is important to note howMarkCurDbQItmAsDone does its work: Internally, an UPDATE and COMMIT operation (ChgRec) is used to change the status and set the queue record's Last Modified info appropriately. To do this operation, the WHERE clause of the UPDATE is set to the unique key of the queue record, and this operation must succeed or a fatal error is thrown. No other process is allowed to pick up and modify a queue record that has a status of “InProcess” (other than for cleaning up after a crash), so not finding the record (with the correct status) is a programming error.

Other data base operation can be combined with MarkCurDbQItmAsDone as follows. As soon as the status has been changed, MarkCurDbQItmAsDone issues a database COMMIT immediately. The application can elect to combine this COMMIT with a previous set of database operations—for essentially guaranteed recoverability. (When an application design avoids this sort of multi-record transaction, performance and deadlock resistance is improved.)

Multiple queue items can be processed at the same time as follows. When efficiencies are gained by “batching” queue requests together, an application can get one queue record after the other, and then do the work on them together. For example, an application could pick up an optimal batch of related records until some maximum number is reached for that message or until an unrelated record is picked up from the queue. When a record is picked up that should not be part of the batch, the application has the option of holding it for subsequent processing or returning it to the queue. That is done by calling MarkCurDbQItmAsWaiting, which returns the availability of this item for other queue readers (by taking the record out of “InProcess” status).

Collisions are avoided in a cleanup after a crash as follows. Only one application instance at a time should be allowed to change an “InProcess” queue item's status. This is safest for cleanup after a crash as well. However, if multiple instances of a cleanup application can be working at the same time on the same set of queue items, then the cleanup application must trap the error that occurs when a queue item is not found. It is usually preferable for each cleanup application instance to operate on a different set of crashed queue items (e.g. by supplying the crashed User Code as a parameter to FindInProcessDbQItm).

Member function: clsRecDbQ::MarkCurDbQItmAsWaiting
Full name: Mark Current Db Queue Item As Waiting Function of clsRecDbQ

The purpose of this function is to indicate that processing has been cancelled on the queue item by the application. When the application cancels a task, the application puts the item back on the queue by calling MarkCurDbQItmAsWaiting, which sets the Database Queue Item Status back to “Waiting”. The queue item must start out in “InProcess” status and must be found or an error is thrown.

Member function: clsRecDbQ::FindInProcessDbQItm
Full name: Find In Process Database Queue Item Function of clsRecDbQ

The purpose of this function is to find the database queue item whose status is “InProcess”. It is needed only when an application handles multiple queue items simultaneously. In this case, the program needs to find not only the Current queue item, but also queue items previously retrieved.

Given the “key” of a database queue item, FindInProcessDbQItm moves to the specified queue item, whose status must be “InProcess”. It is a programming error not to find the database queue given its unique key. This is because no other application or process other than the current application should have altered the status of the queue item whose status has been set to “InProcess” by the current application.

This function is used when multiple queue items are being processed as a “batch” of work, then when the work is done, the application needs to mark all the queue items as done. To do this, it must store the primary key info for each record. Once the work is completed, the application calls FindInProcessDbQItm( ) repeatedly and sets the status as “ProcessDone” using MarkCurDbQItmAsDoneo.

Member function: clsRecDbQ::GetNextDoneDbQItm
Full name: Get Next Done Database Queue Item Function of clsRecDbQ

The purpose of GetNextDoneDbQItm is to retrieves the next queue item (record) that has a Database Queue Status of “ProcessDone”, so that it is available for deletion. When GetNextDoneDbQItm( ) finds a record, the application can immediately issue a DelCurDbQItm( ) to permanently delete the record from the queue.

GetNextDoneDbQItm either returns the queue item successfully or returns a “NoDataFound” completion code.

In the present embodiment, GetNextDoneDbQItm performs its work by doing a SELECT for a SINGLE record in “ProcessDone” status and releases all locks. On each invocation of GetNextDoneDbQItm( ), the function continues walking forward through the index looking for “ProcessDone” records and retrieves a queue record until there are no more “ProcessDone” records. After that, the next time GetNextDoneDbQItm( ) is called, the search starts from the beginning of the index again.

Member function: clsRecDbQ::DelCurDbQItm
Full name: Delete Current Database Queue Item Function of clsRecDbQ

The purpose of this function is to delete the current Database Queue record, which must have a Database Queue Status of “ProcessDone”. DelCurDbQItm has NO effect on the Payload record associated with the queue item being deleted.

The usage of this function is that applications that get queue items are responsible for regularly looping through the queue and cleaning up queue records that are no longer needed. “ProcessDone” records should be deleted regularly by the application that does the retrieval (GetNextWaitingDbQItm)—but not immediately on setting “ProcessDone”. Otherwise, locking will cause unnecessary locking on the index pages that are most in use.

“ProcessDone” queue records are mostly at the “FRONT” (top) of the index (at least temporarily, depending on Priority) and must be skipped over during subsequent calls to GetNextWaitingDbQItm. This means that the record deletion operations will mainly tie up different pages of the index than the MarkCurDbQItmAsDone and AddDbQItm operations. On the other hand, if too many “Done” records are allowed to accumulate, then it gets too expensive to skip over them.

Therefore, the application should regularly stop calling GetNextWaitingDbQItm, in order to invoke the GetNextDoneDbQItm and DelCurDbQItm operations. In this continuous cleaning model, every so often, the program removes some or all of the records marked “ProcessDone”. For example, a program might call GetNextDoneDbQItm and DelCurDbQItm repeatedly in a loop, once for every 100 GetNextWaitingDbQItm calls. This eliminates the need for separately scheduled deletion jobs and keeps the queue cleaned up under intensive use.

This function returns: APP_RetCodOk or COMPLET_RecToDelNotFound (because another user has already deleted)

DelCurDbQItm does its work by picking up the records, which must be marked “ProcessDone” and does the required cleanup (deletion operation). One record is deleted and committed at a time (so that multiple application instances can work simultaneously without deadlocking).

In a typical cleanup, the application calls GetNextDoneDbQItm to continue walking forward through the index, looking for “ProcessDone” records and retrieving them. Each time a queue record is found, DelCurDbQItm is invoked by the application to delete one record. Optionally, the application can retrieve the payload directly into a separate Record Base buffer and delete it and related records.

The application continues repeated deletion until one of two conditions is reached:
a) When DelCurDbQItm encounters a NOT FOUND condition while performing a deletion because some other process has already deleted this record (so the WHERE clause in the DELETE statement fails to find the uniquely-keyed record); or
b) End of data reached.
   Member function: clsRecDbQ: :GetNextCrashedDbQItm
   Full name: Get Next Crashed Database Queue Item Function of clsRecDbQ

The purpose of the function GetNextCrashedDbQItm is to find queue records that were in flight at the time of a crash. This is not only useful for recovery, as described below, but also can be used to display all effected items prior to recovery processing. After a crash, there can be one or more queue records left in “InProcess” status even though the process that was doing the associated work has disappeared. Such queue records must be “fixed”.

Besides the primary key, a Database Queue record also contains additional fields, especially useful for recovery after a severe crash. These are the “Last Modified” fields, including the Date, Time, and User Code for the application that is doing modification (which may belong to a Batch User, a web server, or whatever process is adding and changing queue records). Whenever the Database Queue Item Status in a record is changed, this User Code is updated and available for use in recovering “InProcess” Queue Items if an application crash takes place.

The GetNextCrashedDbQItm function searches for an “InProcess” record Last Modified by the specified database user (application). The first time it is called during the life of a Database Queue Class instance, it starts the search from the beginning of the queue - in primary key order. Thereafter, if called again with the SAME User Code, it continues forward through the index, until a “NoDataFound” completion is returned. Whenever the User Code changes or “NoDataFound” is returned, GetNextCrashedDbQItm starts its search from the top of the index.

The following is a typical Database Queue recovery scenario:

1. A Batch application (engine) crashes after picking up work:

Crash leaves Queue Item Status as “InProcess”.

The Last Modified User Code is the one belonging to the crashed process.

2. “Cleanup” application (engine) finds and fixes any “orphaned” record(s) from this user's crash:

The Last Modified User Code for the failed process is the input for cleanup.

Cleanup program loops through in index order until no more bad records:
a) calls GetNextCrashedDbQItm to retrieve the next bad record (starting from the last bad record found if any). (Looping is only necessary if more than one queue record at a time is handled by an instance of the crashed application.)
b) optionally, the cleanup application may do some cleanup work
c) calls MarkCurDbQItmAsWaiting or MarkCurDbQItmAsDone, which changes Status either to “Waiting” (to resubmit) or “ProcessDone” (to mark for deletion). Both functions do a database COMMIT immediately after the UPDATE (ChgRec).
d) COMPLET_NoDataFound returned when all bad records have been retrieved. Now, it is safe to restart the crashed application, which can safely make use of the User Code (since cleanup is completed).
   Member function: clsRecDbQ::SetPrepareDbCmdFlag
   Full name: Set Prepare Database Command Flag Function of clsRecDbQ

The purpose of this function is to improve performance if the database queue buffer is going to be used to perform the same function repeatedly. The parameter (Flag) value of TRUE or FALSE indicates whether the next database command executed in clsRecDbQ should be prepared for efficient, repetitive invocation.

In this command, the prepared execution is faster than the default, direct execution, for database commands (SQL statements) executed more than once, primarily because the backend database system can compile the command only once. Compilation involves the database system's determining the plan (access path selection), such as which index to use. This compilation step can be relatively expensive compared to actual execution.

The Record Database Queue class allows for the automatic preparation of two database commands at the same time. This avoids the programming needed to code switching between two database buffers when normal processing of the queue involves rapid switching back and forth between two operations.

The preparation of a database command can significantly speed multiple executions and reduce the load on the database server and network. Invoking this efficiency improvement for Database Queues does NOT require any special programming, and can be used safely without testing for timing comparisons on whether or not prepare is done.

Invoking SetPrepareDbCmdFlag( TRUE ) reserves the queue buffer for two operations to be prepared and performed repeatedly, with only specific data parameters being changed on each invocation. This is often the most efficient way to perform repeated operations such as:

GetNextWaitingDbQItm( ) plus MarkCurDbQItmAsDone( );

FindInProcessDbQItm( ) plus MarkCurDbQItmAsDone( );

GetNextDoneDbQItm( ) plus DelCurDbQItm( ); or

GetNextCrashedDbQItm( ) plus MarkCurDbQItmAsWaiting( )

For repeated use, AddDbQItm( 0 only requires a single prepared statement. MarkCurDbQItmAsDone( ) and MarkDbQItmAsWaiting( ) also only require a single prepared statement between the two of them. Thus, two prepared statements is all that is needed to efficiently execute all common patterns of operations on a Database Queue record.

The actual database Prepare is delayed until the first, subsequent execution after SetPrepareDbCmdFlag(TRUE) is issued. The prepared state is maintained after commit or rollback.

SetPrepareDbCmdFlag(FALSE) returns the queue buffer to the default mode, direct execution. Any database system resources that are tied up are released, terminating the existing command preparation, if any. The queue buffer is cleared, thereby clearing the existing contents of the input and output parameters and previously obtained return value if any.

This function call can be made at any point after InitDbQItm( ). Once set to TRUE, two functions of clsRecDbQ can be called repeatedly. The prepared state and the associated database resources are maintained until either FreeRecDbQBuf( ) or SetPrepareDbCmdFlag( FALSE ) is issued, which ends the freezing of the commands for the buffer.

Member function: clsRecDbQ::GetDbBufState
Full name: Get Database Buffer State of clsRecDbQ

The purpose of this function is to save the current state of the database buffer. This function is used so that the current state of the database buffer is saved in a string format which makes it suitable for standard web transmission. All the required information is saved so that using SetDbBufState( ) the database buffer can be reconstructed to the saved state. Note that actual database data contained in the result set is not saved. Using the saved state information, the database buffer can reconstruct the SQL query and attempt to obtain the same database data afresh from the database.

Saving the description of a Database Buffer for subsequent re-use is particularly applicable to “stateless”, server-side, web programming.

GetDbBufState can be called any time after Init has been done on the database buffer.

This function returns a string containing the current database buffer state.

Member function: clsRecDbQ::SetDbBufState
Full name: Set Database Buffer State of clsRecDbQ

The purpose of this function is to set the state of the database buffer to the state saved earlier. This function is used so that SetDbBufState can be called on a database buffer any time by passing the database buffer state string that was retrieved earlier using GetDbBufState. Calling SetDbBufState sets up the current record position. Note that after SetDbBufState the database buffer gets reconstructed to its saved state but without doing a database retrieval. Calling SetDbBufState leaves the database buffer ready to perform the database operation. The actual database data can be obtained by making a database query using functions such as GetNextWaitingDbQItm.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is Claimed is:

1. A method of distributed batch processing wherein a plurality of substantially independent tasks access a common database, wherein a queue contains a plurality of index entries in an index for ordering a corresponding plurality of substantially independent tasks, and wherein the index entries are not moved within said queue during execution of the corresponding independent task.

2. The method of distributed batch processing of claim 1 wherein the queue includes a first portion wherein the index entries are added to the queue, thereafter moving through the queue to a second portion, wherein the index entries are executed.

3. The method of distributed batch processing of claim 2 wherein the queue includes a third portion, to which index entries move after execution and wherein index entries are deleted.

4. The method of distributed batch processing of claim 1 wherein said queue consists of one and only one queue.

5. The method of distributed batch processing of claim 2 wherein the index entries are executed based at least in part on first-in-first-out order.

6. The method of distributed batch processing of claim 2 wherein the index entries are executed based at least in part on priority order.

7. The method of distributed batch processing of claim 2 wherein the index entries are executed based on both first-in-first-out order and priority order.

8. The method of distributed batch processing of claim 1 wherein said queue is configured and arranged as a database table.

9. The method of distributed batch processing of claim 8 wherein said database table is configured and arranged to include index entries of different formats.

10. The method of distributed batch processing of claim 9 wherein said different formats can point to payloads of different lengths.

11. The method of distributed batch processing of claim 1 wherein a plurality of input devices enter index entries into said queue.

12. The method of distributed batch processing of claim 1 wherein a plurality of processing devices execute index entries.

13. The method of distributed batch processing of claim 12 wherein said processing devices are application servers.

14. The method of distributed batch processing of claim 1 wherein processing of the data entries includes the states of waiting, in-process, and done.

15. The method of distributed batch processing of claim 14 wherein processing of a data entry from the in-process state can transition to said waiting state or can transition to said done state.
